(19) United States
(12) Patent Application Publication
(10) Pub. No.: US 2014/0315506 A1
(43) Pub. Date: Oct. 23, 2014

(54) DETERMINING RADAR SUB-CHANNEL IN COMMUNICATION NETWORKS

(71) Applicant: QUALCOMM Incorporated, San Diego, CA (US)

(72) Inventors: Meriam Khufu Ragheb Rezk, Campbell, CA (US); Richard Melvin Mosko, JR., London (GB); Mahboobul Alem, Fremont, CA (US)

(73) Assignee: QUALCOMM Incorporated, San Diego, CA (US)

(21) Appl. No.: 14/247,126

(22) Filed: Apr. 7, 2014

Related U.S. Application Data
(60) Provisional application No. 61/813,631, filed on Apr. 18, 2013.

(51) Int. Cl. H04W 24/08

(52) U.S. Cl. CPC H04W 24/08
USPC 455/130

(57) ABSTRACT

A wireless device operating within a wireless communication channel can detect radar signals in one or more sub-channels using sub-channel counter information. The wireless device can receive signal pulses and generate Fast Fourier Transform values based on the signal pulses. The sub-channel counters can be incremented based on the Fast Fourier Transform values. The wireless device can determine whether the received signal pulses include a radar signal based, at least in part, on the values of the sub-channel counters.

### BACKGROUND

Embodiments of the inventive subject matter generally relate to the field of communication systems and, more particularly, to radar signal detection in sub-channels of a wireless communication channel.

Wireless devices can be configured to operate with radar devices by sharing frequencies in the 5 GHz frequency band. For example, a wireless device can vacate operations in the shared frequency band when the radar signals are detected to avoid interfering with the radar devices. Detecting radar signals can be difficult due to signal interference and/or communication activity of the wireless device. False radar signal detection can cause the wireless device to vacate the shared frequency band unnecessarily.

### SUMMARY

Various embodiments of a wireless device configured to detect radar signals are disclosed. The wireless device can receive signal pulses via a wireless communication channel. In one example, the wireless communication channel can include a first sub-channel. In another example, the wireless communication channel can include the first sub-channel and one or more additional sub-channels. In one embodiment, Fast Fourier Transform (FFT) output peaks can be generated based on the received signal pulses. A first sub-channel counter can be incremented based, at least in part, on the FFT output peaks. The first sub-channel counter is associated with the first sub-channel of the wireless communication channel. The first sub-channel counter can be used to determine whether a radar signal is present within the first sub-channel of the wireless communication channel

### BRIEF DESCRIPTION OF THE DRAWINGS

The present embodiments may be better understood, and numerous objects, features, and advantages made apparent to those skilled in the art by referencing the accompanying drawings.

FIG. 1 is a block diagram of one embodiment of a communication system.

FIG. 2 is a block diagram of one embodiment of a wireless transceiver.

FIG. 3 is a drawing showing an example relationship between a Fast Fourier Transform output and sub-channels of a wireless communication channel.

FIG. 4 is a flow diagram illustrating example operations of one embodiment of a wireless device.

FIG. 5 is a flow diagram illustrating example operations of another embodiment of a wireless device.

FIG. 6 is a flow diagram illustrating example operations of yet another embodiment of a wireless device.

FIG. 7 is a block diagram of one embodiment of an electronic device including a pulse characterization module.

### DESCRIPTION OF EMBODIMENT(S)

The description that follows includes exemplary systems, methods, techniques, instruction sequences and computer program products that embody techniques of the present inventive subject matter. However, it is understood that the described embodiments may be practiced without these specific details. For instance, although examples refer to wireless receivers, the described embodiments can be applied to wireless transceivers as well. In other instances, well-known instruction instances, protocols, structures and techniques have not been shown in detail in order not to obfuscate the description.

Wireless devices, such as wireless local area network (WLAN) access points and stations, can receive and transmit signals through a wireless communication channel specified by the operational mode of the wireless devices. For example, operational modes of a wireless device transmitting in the 5 GHz frequency band can be described by the IEEE 802.11ac draft specification. The operational modes can correspond to a bandwidth used by the wireless device. For example, a first operational mode can use 20 MHz of bandwidth, while a second operational mode can use 40 MHz of bandwidth. Additionally, the wireless device can operate in 80 MHz and 160 MHz operational modes. The wireless communication channel used by the wireless device can be divided into sub-channels. In some implementations, each sub-channel can have a bandwidth of 20 MHz. The sub-channels can be adjacent to each other, or the sub-channels can be separate from each other (i.e., other sub-channels or frequency bands can be disposed between the sub-channels).

Some wireless devices can operate with radar devices by sharing portions of the 5 GHz frequency band. Radar signals can include signature (or unique) signal pulse characteristics. For example, different radar signals can be identified by signal pulse characteristics such as signal pulse width, pulse repetition interval and signal pulse received signal strength. Wireless devices can detect and identify radar signals by comparing characteristics of received signal pulses to these signal pulse characteristics.

Regulatory agencies have specified that wireless devices should be designed to detect radar signals and vacate operations if radar signals are detected. For example, if an in-band radar signal (i.e., a radar signal located within the wireless communication channel used by the wireless device) is detected, the wireless device shall vacate operations in the wireless communication channel for a predetermined amount of time. In some cases, when the wireless device is operating as an access point, the wireless device can coordinate a frequency change for itself and any other wireless devices communicating with the access point. Such frequency changes can take time to coordinate. Unused frequency bands may need to be located and then the wireless devices associated with the access point may need to move to the new frequency band. During this “search and move” activity, the performance of the access point and the wireless devices associated with the access point may suffer since the access point and the wireless devices cannot transfer data. Typically, when the wireless device vacates operations, the wireless device ceases all transmissions in the currently used wireless communication channel. For example, if the operational mode uses a 160 MHz wireless communication channel, then the wireless device stops transmitting within that 160 MHz wireless communication channel. Therefore, even if the radar signal is present in only a portion of the 160 MHz wireless communication channel, the entire wireless communication channel is left vacant. Vacating the entire wireless communication channel causes inefficient use of the otherwise available wireless frequencies in the wireless communication channel.

In one embodiment, a wireless device can analyze received signal pulses and track Fast Fourier Transform (FFT) output peaks of the signal pulses. The FFT output peaks can be used to determine if a radar signal is present in some of the frequencies of the wireless communication channel. If a radar signal is detected, the wireless device can vacate operations in some frequencies of the wireless communication channel while maintaining operations in other frequencies of the wireless communication channel where a radar signal was not detected.

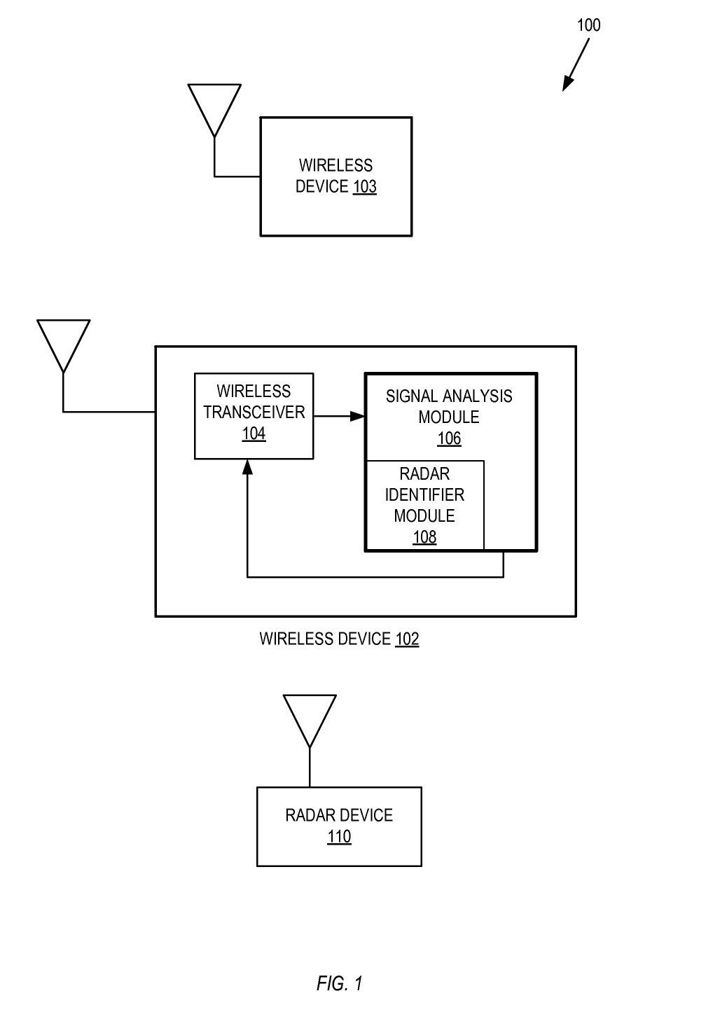

FIG. 1 is a block diagram of one embodiment of a communication system 100. The communication system 100 can include wireless devices 102 and 103 and a radar device 110. The wireless devices 102 and 103 can establish a wireless communication channel between them for transmitting and receiving signals. The radar device 110 can also use a portion of the wireless communication channel. The wireless devices 102 and 103 can include a laptop computer, a tablet computer, a wireless access point, a wireless-enabled display, a mobile phone, a smart appliance (PDA), or other electronic devices that are configured to implement wireless communication protocols (e.g. IEEE 802.11 protocols). The wireless devices 102 and 103 can be configured to detect radar signals that are generated by the radar device 110 and that are present within the wireless communication channel. As a result of the detection, the wireless devices 102 and 103 can vacate operations in portions of the wireless communication channel that include the radar signal. For example, the wireless device 102 can operate in a 40 MHz operational mode (i.e., the wireless communication channel is 40 MHz wide) and detect a radar signal within a 20 MHz portion of the wireless communication channel. The wireless device 102 can then vacate operations in the 20 MHz portion of the wireless communication channel with the detected radar signal. Operations can continue in the 20 MHz portion of the wireless communication channel where the radar signal was not detected.

The wireless device 102 can include a wireless transceiver 104 and a signal analysis module 106. Although not shown in FIG. 1, the wireless device 103 can also include a wireless transceiver and a signal analysis module. The wireless transceiver 104 can transmit/receive wireless communication signals to/from other wireless devices. The wireless device 102 can be configured in one of a plurality of available operational modes for transmitting and receiving data. For example, the wireless device 102 can operate in a 20 MHz, a 40 MHz (e.g., HT 40), an 80 MHz or a 160 MHz operational mode. The wireless communication channel can be based on the operational mode and can be divided into sub-channels. In one embodiment, each sub-channel is associated with a 20 MHz wide frequency band. For example, when the wireless device 102 operates in the 40 MHz operational mode, the wireless device 102 can use a wireless communication channel that can be divided into two 20 MHz sub-channels. If the wireless device 102 operates in the 160 MHz operational mode, then the wireless device 102 can use a wireless communication channel that can be divided into eight 20 MHz sub-channels. In other embodiments, the sub-channels can be associated with frequency bands that have different bandwidths. For example, a sub-channel can be 40 MHz or 80 MHz wide. In still another embodiment, the wireless communication channel can be divided into sub-channels that are unequal in size. For example, if the wireless device 102 operates in the 80 MHz operational mode, the wireless communication channel can be divided into one 40 MHz and two 20 MHz wide sub-channels.

The wireless transceiver 104 can receive wireless communication signals and signal pulses and provide signal pulse information, including signal pulse characteristics, to the signal analysis module 106. The wireless transceiver 104 can receive wireless communication signals, such as signals described in a version of the IEEE 802.11 specification. The wireless transceiver 104 can also receive signal pulses of a radar signal. The wireless transceiver 104 can determine the signal pulse characteristics of the received signal pulses including, but not limited to, signal pulse width, signal pulse received signal strength, and pulse repetition interval. The wireless transceiver 104 can then provide the signal pulse characteristics to the signal analysis module 106.

In addition to the signal pulse characteristics, the signal pulse information provided by the wireless transceiver 104 to the signal analysis module 106 can also include sub-channel counter information. In one embodiment, the received signal pulse can be processed with an FFT operation. The wireless transceiver 104 can track a peak value of the result of the FFT operation with respect to the wireless communication channel used by the wireless device 102 using sub-channel counters. The sub-channel counters can be assigned to 20 MHz wide frequency segments (or sub-channels) of the wireless communication channel. In another embodiment, the sub-channel counters can be assigned to 20 MHz wide segments in and near the wireless communication channel used by the wireless device 102. For example, if the wireless device operates in a 40 MHz operational mode, then two sub-channel counters can be assigned to two 20 MHz segments coincident with the frequencies used by the wireless device. Additional sub-channel counters can be assigned to other frequency segments adjacent to the two 20 MHz segments. As each FFT of the signal pulse is determined, the corresponding sub-channel counter can be incremented. For example, if an FFT peak value has a frequency that is within a frequency segment used by the wireless device, then the sub-channel counter corresponding to that frequency segment can be incremented. Radar signals can be narrowband signal pulses. For example, radar signals can be between 5 and 10 MHz wide. The sub-channel counters described above can be configured to count narrowband FFT output peaks to determine if a radar signal is included in one of the corresponding frequency segments (or sub-channels). The values of the sub-channel counters (i.e., the sub-channel counter information) are provided to the signal analysis module 106.

In one embodiment, the signal analysis module 106 can examine the values of the sub-channel counters (or the sub-channel counter information) included with the signal pulse information. The signal analysis module 106 may determine which of the sub-channel counters to use for radar detection depending on the operational mode of the wireless device 102. As described above, the operational mode can determine certain characteristics of the wireless communication channel. For example, the operational mode may use 80 MHz of frequency bandwidth; therefore, the wireless communication channel for the wireless device 102 can be 80 MHz wide. In some embodiments, some of the frequencies may not be used in a particular operational mode of the wireless device 102 and therefore may not be included within the wireless communication channel. In this embodiment, the sub-channel counters that are associated with the frequencies that are not used with a particular operational mode can be ignored. The sub-channels that are associated with frequencies that are used by the wireless device 102 may be “qualified” or “validated.”

The sub-channel counters associated with frequency segments or sub-channels that are within the wireless communication channel can detect possible radar signals within one or more sub-channels. For example, a non-zero sub-channel counter can indicate the presence of a signal pulse (and therefore a possible radar signal) in the corresponding (or associated) sub-channel. However, if the non-zero sub-channel counter is not within the wireless communication channel as determined by the operational mode (i.e., the sub-channel counter has not been validated), then the non-zero sub-channel counter can be ignored. That is, although a possible radar signal may exist in an adjacent sub-channel, since the adjacent sub-channel is not within the wireless communication channel, the radar signal can be ignored. In some embodiments, a radar identifier module 108 included in the signal analysis module 106 can use a detection threshold to detect the radar signal. For example, the radar identifier module 108 can determine that the radar signal is detected when the value of the sub-channel counter is non-zero and greater than the detection threshold. The detection threshold may be a predetermined count value of first sub-channel counter for determining the presence of the radar signal. Thus, the detection threshold can prevent false radar signal detection by allowing a predetermined number of peak FFT values to be counted before determining that the radar signal is detected.

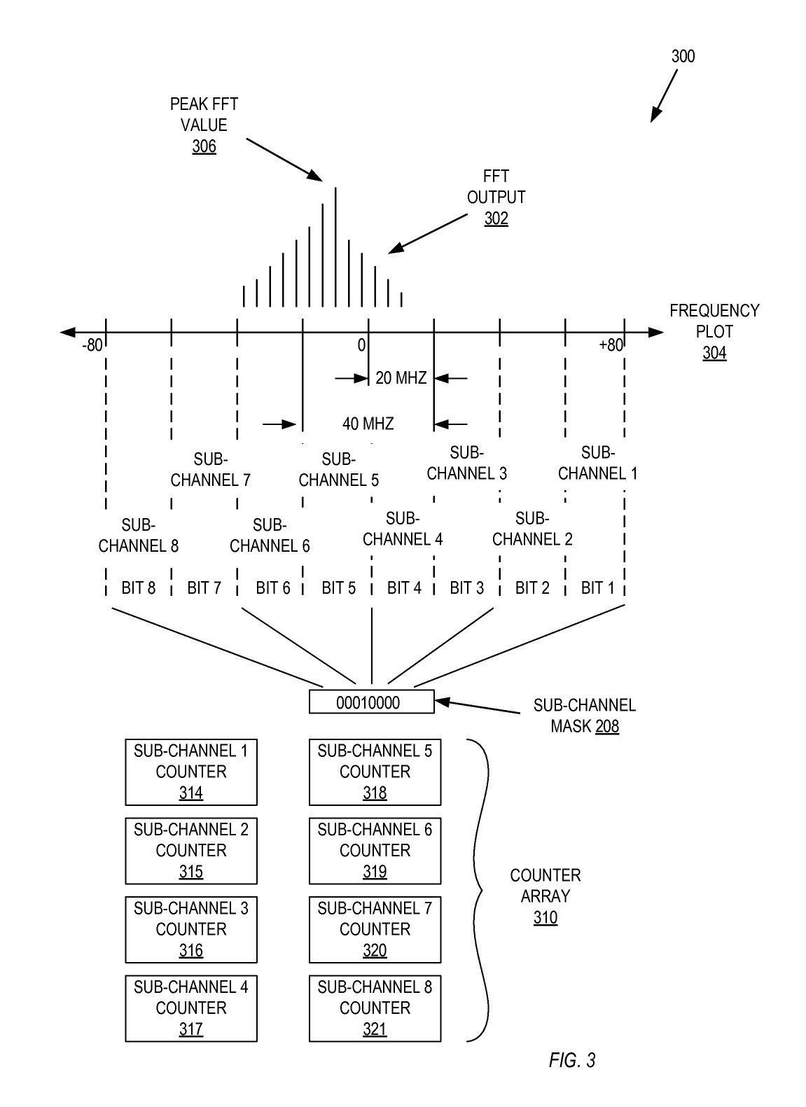

The signal analysis module 106 can direct the wireless transceiver 104 to vacate operations in at least the sub-channel of the wireless communication channel where the radar signal has been detected. In some cases, the wireless transceiver 104 may not need to leave the entire wireless communication channel altogether, but can vacate operations in one or more sub-channels where a radar signal has been detected, while maintaining operations in at least one sub-channel of the wireless communication channel. In situations where operations can be vacated from a subset of the sub-channels, bandwidth may be reduced and no additional time may be needed to search for an unoccupied frequency. The operations of the sub-channel counters and operations for detecting radar signals using the sub-channel counter information are described in more detail below in conjunction with FIGS. 3, 4 and 5.

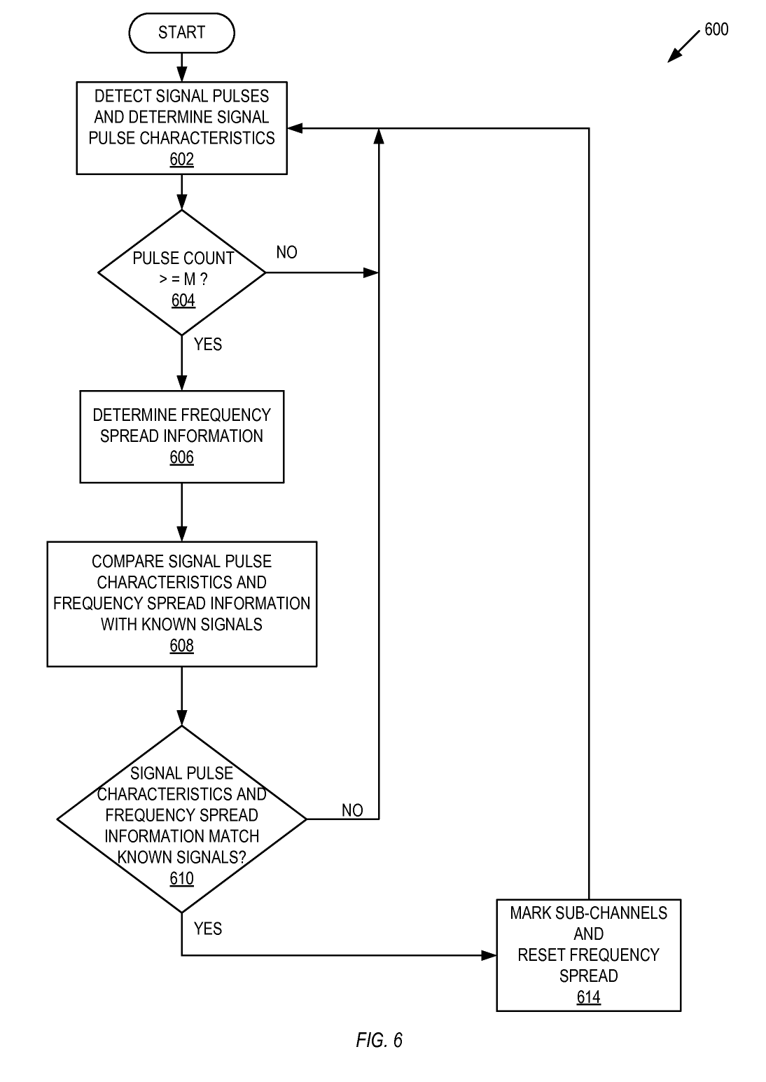

It is noted that in other embodiments the wireless device 102 can implement other techniques in addition to (or instead of) the techniques described above for detecting radar signals. In some embodiments, the wireless device 102 can implement a radar pattern matching technique to detect radar signals. In one implementation, after the wireless transceiver 104 receives a signal pulse, the signal analysis module 106 can receive the signal pulse characteristics from the wireless transceiver 104 and can determine a frequency spread of FFT outputs based, at least in part, on the received signal pulse. The radar identifier module 108 can determine whether a radar signal is present within the wireless communication channel by pattern matching the received signal pulse characteristics with signal pulse characteristics of known radar signals, and by comparing the determined frequency spread of FFT outputs to an expected frequency spread of FFT outputs of known radar signals. In one embodiment, the radar identifier module 108 can include one or more pattern matching filters that can compare the signal pulse characteristics with the signal pulse characteristics of known radar signals. If the radar identifier module 108 detects a radar signal, the signal analysis module 106 can then use the frequency spread of FFT output to determine if the radar signal is located within the wireless communication channel used by the wireless device 102. The radar pattern matching technique for detecting radar signals is described in more detail below in conjunction with FIG. 6.

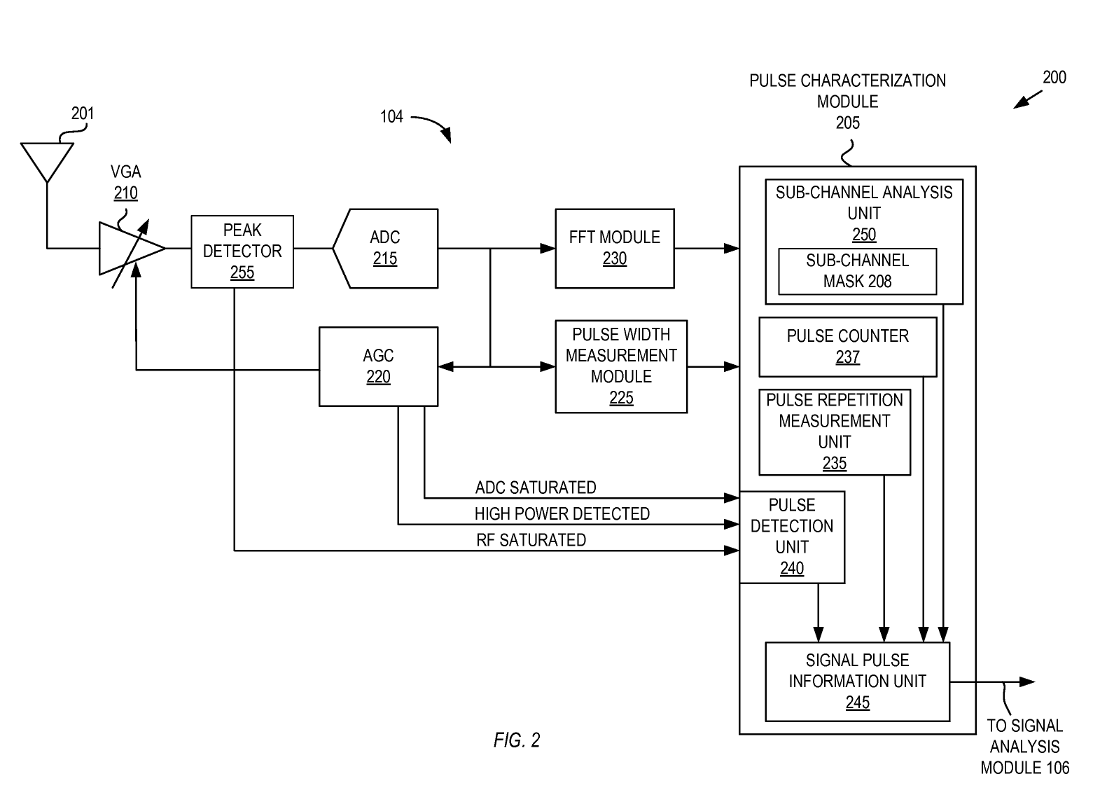

FIG. 2 is a block diagram 200 of one embodiment of the wireless transceiver 104 including a pulse characterization module 205. In one implementation, the wireless transceiver 104 can be included in the wireless device 102 as shown in FIG. 1. Wireless communication signals can be received by an antenna 201 and coupled to an input of a variable gain amplifier (VGA) 210. An output of the VGA 210 can be coupled to an input of an Analog-to-Digital Converter (ADC) 215. An output of the ADC 215 can be coupled to an Automatic Gain Controller (AGC) 220. The AGC 220 can monitor the output of the ADC 215 and can increase or decrease a gain setting of the VGA 210 to adjust the input signal of the ADC 215. For example, if the output of the ADC 215 is saturated (e.g., the ADC output does not respond to changes to the input of the ADC 215), then the AGC 220 can reduce the gain setting of the VGA 210. On the other hand, if the output of the ADC 215 is too small, then the AGC 220 can increase the gain setting of the VGA 210.

The output of the ADC 215 can also be coupled to a pulse width measurement module 225. The pulse width measurement module 225 can determine the signal pulse width (in the time domain) of the output from the ADC 215. The output of the ADC 215 can also be coupled to a FFT module 230. The FFT module 230 can perform an FFT operation on the output from the ADC 215. The output of the FFT module 230 and an output of the pulse width measurement module 225 can be coupled to the pulse characterization module 205. An ADC saturated signal and a high power detected signal can be coupled from the AGC 220 to a pulse detection unit 240. When the input of the ADC 215 receives a strong signal, the ADC 215 can saturate. That is, the strong signal can overwhelm the input to the ADC 215 and cause erroneous outputs from the ADC 215. The pulse detection unit 240 can use the ADC saturated signal to indicate the presence of a pulse, possibly from a radar signal (i.e., the strong signal causing the ADC to saturate). In other embodiments, ADC saturated signal and high power detected signal can be provided by other modules within the wireless transceiver 104. For example, the ADC 215 can provide the ADC saturated signal to the pulse detection unit 240. Usage of the ADC saturated signal and high power detected signal and operation of the pulse detection unit 240 is described in detail below in conjunction with the description of the pulse characterization module 205. A radio frequency (RF) saturated signal can be coupled from the peak detector 255 to the pulse detection unit 240. The RF saturated signal can indicate the presence of a strong RF signal provided to the ADC 215. The pulse detection unit 240 can use the RF saturated signal to indicate the presence of a pulse, possibly from a radar signal. In other embodiments, the RF saturated signal can be provided by the VGA 210 or the ADC 215 (signal pathways not shown).

The pulse characterization module 205 can include the pulse detection unit 240, a sub-channel analysis unit 250, a pulse counter 237, a pulse repetition measurement unit 235, and a signal pulse information unit 245. The pulse detection unit 240 can determine when a signal pulse is being received by the wireless transceiver 104. The pulse detection unit 240 can receive the ADC saturated signal, the high power detected signal and the RF saturated signal. In one embodiment, the pulse detection unit 240 can determine that a signal pulse is received when the ADC 215 output is saturated, a high power signal is detected, and/or an RF saturated signal is received.

The sub-channel analysis unit 250 can track the peak values of FFTs determined by the FFT module 230 with respect to the wireless communication channel used by the wireless device 102. In one implementation, the sub-channel analysis unit 250 can map the peak FFT values from the FFT module 230 to a bit within a sub-channel mask 208. Sub-channel counters (included in the sub-channel analysis unit 250) can track the peak FFT values based on the sub-channel mask 208. The contents of the sub-channel counters can be provided to the signal pulse information unit 245. Sub-channel counters can be implemented in software, hardware and/or firmware. Operation of the sub-channel analysis unit 250 (including the sub-channel mask 208 and the sub-channel counters) is described in greater detail in conjunction with FIG. 3 below.

The pulse counter 237 can determine how many signal pulses are detected. In one embodiment, functionality performed by the pulse counter 237 can be performed by the pulse detection unit 240. The pulse repetition measurement unit 235 can measure the time between detected signal pulses to determine a pulse repetition interval (PRI). In another embodiment, functionality performed by the pulse repetition measurement unit 235 can be performed by the pulse detection unit 240.

The signal pulse information unit 245 can provide the sub-channel counter information and the signal pulse characteristics such as PRI, pulse counts, signal pulse width and signal pulse received signal strength to the signal analysis module 106. In one embodiment, the sub-channel counter information from the signal pulse information unit 245 can be used to detect whether a radar signal is within one or more sub-channels used by the wireless device 102. For example, a radar signal can be detected based, at least in part, on values of the sub-channel counters. In some embodiments, sub-channel counter information from the signal pulse information unit 245, and not the signal pulse characteristics, is used to detect the radar signal. This is described in more detail below in conjunction with FIGS. 3, 4 and 5. In other embodiments, the signal pulse characteristics provided by the signal pulse information unit 245 can be used to detect a radar signal. For example, a radar signal can be detected by comparing the signal pulse characteristics with signal pulse characteristics of known radar signals. This is described in more detail below in conjunction with FIG. 6.

FIG. 3 is a drawing 300 showing an example relationship between a Fast Fourier Transform (FFT) output 302 and sub-channels of a wireless communication channel. The FFT output 302 can be generated by the FFT module 230 described above. A frequency plot 304 may be divided into sub-channels with each sub-channel having a predefined bandwidth. In one example, as shown in FIG. 3, each sub-channel can be approximately 20 MHz wide. In this example, the frequency plot 304 can be about 160 MHz wide, which can coincide with a continuous bandwidth as described in the draft IEEE 802.11 ac specification.

In some implementations, the sampling rate of the ADC 215 can be such that the FFT output 302 is greater than the bandwidth of the operational mode of the wireless device 102. For example, if the wireless device 102 is operating in a 20 MHz mode, the FFT output 302 can exceed a 20 MHz sub-channel. As shown in FIG. 3, the FFT output 302 can exceed a bandwidth of sub-channel 5 and can have non-zero values in sub-channel 4 and sub-channel 6. In one implementation, the FFT output 302 can span the entire 160 MHz band of the frequency plot 304. In another implementation, the FFT output 302 can be configured to have frequency bins corresponding to the sub-channel band edges and in-band and out-of-band boundaries. In yet another implementation, the FFT output 302 can be configured to have half-rate (10 MHz) and quarter-rate (5 MHz) FFT bins. Half rate and quarter rate FFT bins may provide more frequency detail regarding received signal pulses. As shown, the FFT output 302 can have a peak FFT value 306. In this example, the peak FFT value 306 appears in sub-channel 5.

The sub-channel mask 208 can indicate the sub-channel of the wireless communication channel that includes the peak FFT value 306. In one implementation, one bit in the sub-channel mask 208 is mapped to each sub-channel of the wireless communication channel. Thus, eight sub-channels can be mapped to a byte as shown here. One bit can be set in the sub-channel mask 208 to indicate that a corresponding sub-channel includes the peak FFT value 306. In one implementation, the bit is set in the sub-channel mask 208 to indicate that the corresponding sub-channel includes a narrowband signal pulse. The narrowband signal pulse can correspond to an instance of the FFT output 302 that can be only one or two FFT bins wide. Thus, in one implementation, the related bit can be set in the sub-channel mask 208 if both conditions (the peak FFT value 306 is in a sub-channel and the FFT output 302 is narrowband) are met. In the example shown in FIG. 3, since the peak FFT value 306 appears within sub-channel 5, the sub-channel mask 208 may be (as expressed in binary) 0b00010000. The sub-channel mask 208 may be an expression of the location of the peak FFT value 306 with respect to the frequency plot 304 for the FFT output 302.

A counter array 310 can include a number of sub-channel counters. The counter array 310 can include a sub-channel 1 counter 314, a sub-channel 2 counter 315, a sub-channel 3 counter 316, a sub-channel 4 counter 317, a sub-channel 5 counter 318, a sub-channel 6 counter 319, a sub-channel 7 counter 320 and a sub-channel 8 counter 321. Each sub-channel counter can correspond to a sub-channel in the wireless communication channel. In one embodiment, each of the eight sub-channel counters can monitor a corresponding bit in the sub-channel mask 208 and can increment when the corresponding bit is set to “1”. Thus, a particular sub-channel counter can count the number of occurrences of the peak FFT value 306 in a particular sub-channel. For example, the sub-channel 1 counter 314 can count the number of times BIT 1 in the sub-channel channel mask 208 is set to a “1”. The sub-channel 2 counter 315 can count the number of times BIT 2 in the sub-channel mask 208 is set to a “1” and so on, up to the sub-channel 8 counter 321. In one embodiment, the FFT output 302 may be produced by the FFT module 230 over a predetermined time period, such as a detection time period. The detection time period can be an arbitrary time period during which the FFT outputs 302 are determined and respective sub-channel counters incremented. In this arrangement, the counter array 310 can capture a history of the peak FFT values 306 within the frequency plot 304 over the detection time period. Thus, while the sub-channel mask 208 can provide a current view of the peak FFT value 306, the counter array 310 can provide a historical view (based on the detection time period) of the previous peak FFT values 306. In one implementation, the counter array 310 and sub-channel mask 208 can be implemented in the sub-channel analysis unit 250. The sub-channel analysis unit 250 can then provide the values of the sub-channel counters and the sub-channel mask 208 to the signal pulse information unit 245. In another implementation, the sub-channel mask 208 can be implemented in the sub-channel analysis unit 250 and provided to the signal pulse information unit 245 and values of the sub-channel counters can be determined by the signal analysis module 106.

As a signal pulse is received by the wireless transceiver 104, the FFT output 302 is generated. The FFT output 302 can vary based on a type of radar signal that may be included in the signal pulse. For example, if the signal pulse is from a type of fixed frequency radar signal, then a single sub-channel counter can be non-zero because the radar signal will have a constant frequency. If the signal pulse is from a type of chirping radar signal, then (depending on a chirp frequency) two or more sub-channel counters for two or more adjacent sub-channels can be non-zero. In one implementation, the number of adjacent, non-zero sub-channel counters can be determined by the chirp frequency and a frequency bandwidth of each sub-channel. If the signal pulse is from a type of hopping radar signal, then a plurality of sub-channel counters for non-adjacent sub-channels can be non-zero. In some embodiments, a detection threshold (as described above) can be used in conjunction with the sub-channel counters. The signal pulses from radar signals can be detected if the value of the sub-channel counter is non-zero and greater than the detection threshold. In other embodiments, a largest value of the sub-channel counter can be used to determine which sub-channel includes the signal pulse, and therefore, the radar signal. For example, if the signal pulse is from a type of fixed frequency radar signal, then the sub-channel counter with the largest value can determine the sub-channel that includes the radar signal. If the signal pulse is from a type of chirping radar signal, then the sub-channel counters with the largest value and an adjacent sub-channel counter with a second largest value can determine the sub-channels that include the radar signal. Using the largest value of the sub-channel counters can reduce false radar signal detections. For example, the wireless device 102 can receive noisy signals without falsely detecting the radar signal.

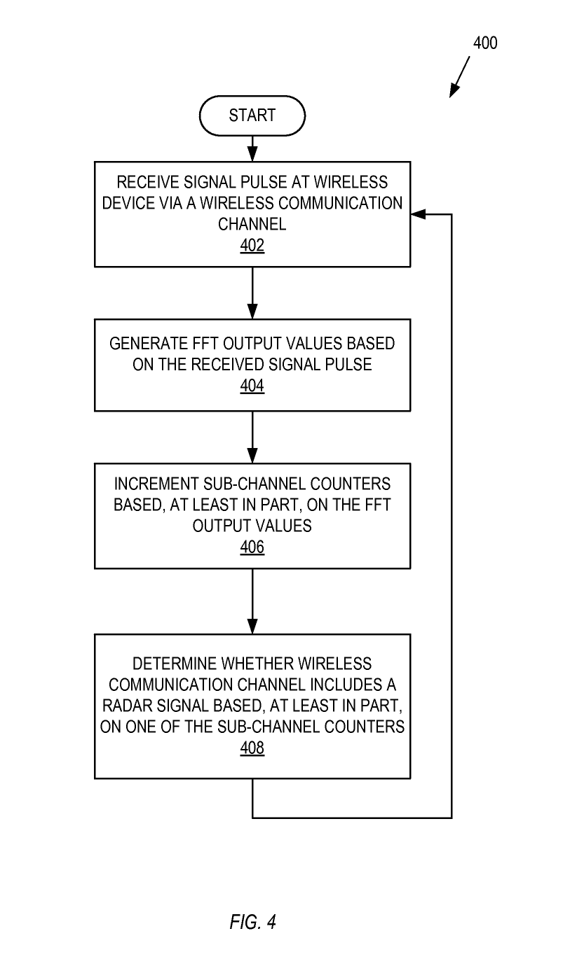

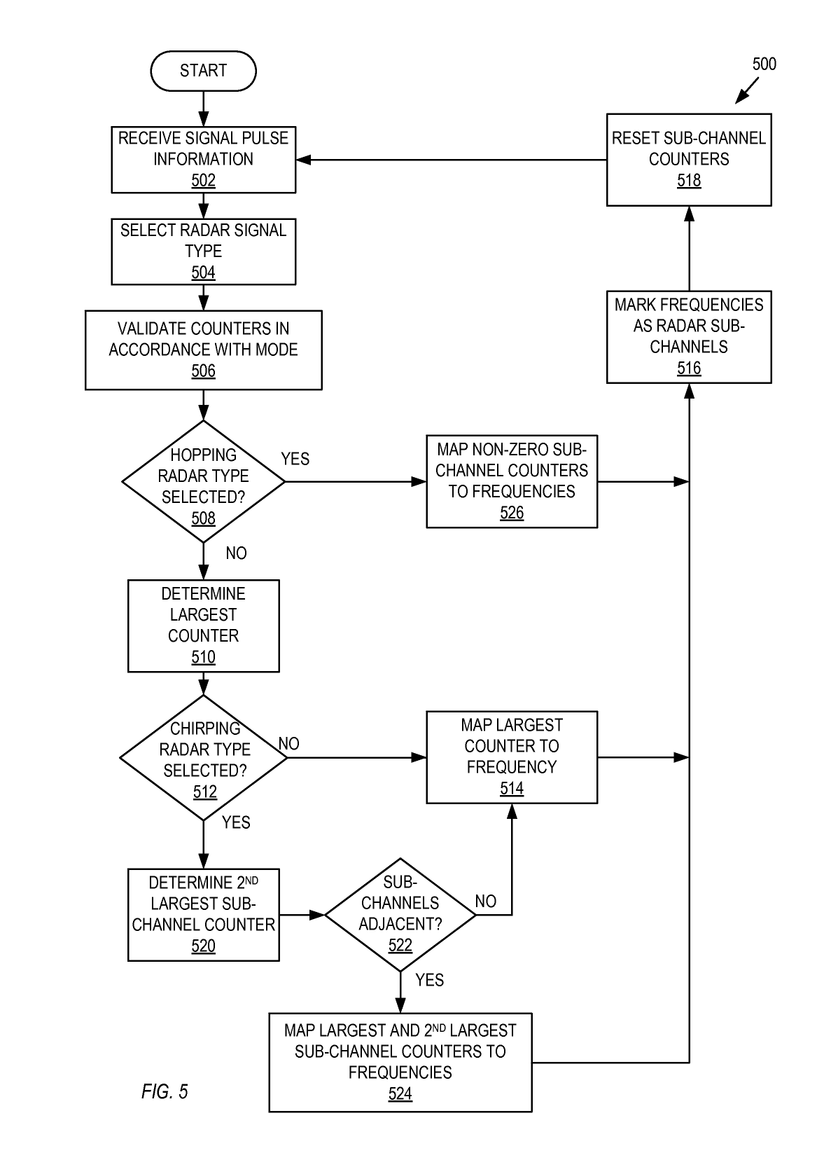

The sub-channel counter information (i.e., the values of the sub-channel counters) can be provided to the signal analysis module 106. The signal analysis module 106 can detect radar signals in the wireless communication channel based, at least in part, on the sub-channel counter information. In one embodiment, the values of the sub-channel counters can be used to determine whether the corresponding sub-channels in the wireless communication channel include the radar signals. In some implementations, the signal analysis module 106 can also determine the type of radar signal that is detected. The detection of radar signals using the sub-channel counter information is described in more detail below in conjunction with FIGS. 4 and 5.

FIG. 4 is a flow diagram 400 illustrating example operations of one embodiment of the wireless device 102. More particularly, the flow diagram 400 describes example operations for determining whether radar signals are present in the wireless communication channel used by the wireless device 102. The flow begins at block 402 where a signal pulse is received at the wireless device 102. In one embodiment, the signal pulse can be received by the wireless transceiver 104 configured to operate in the 5 GHz frequency band. The signal pulse may be received within the wireless communication channel and may be a radar signal. The flow continues to block 404.

At block 404, FFT output values can be generated based on the received signal pulse. In one embodiment, the FFT output values can include the FFT output 302 generated by the FFT module 230. The wireless device 102 can receive additional signal pulses, and the FFT module 230 can generate FFT output values for each received signal pulse. As described above in FIG. 3, the FFT output 302 can include the peak FFT value 306. The signal pulse associated with the peak FFT value 306 can be received via the wireless communication channel being used by the wireless device 102. The wireless communication channel can be divided into a plurality of sub-channels, and each sub-channel can have a predefined bandwidth. One of the sub-channels can include the signal pulse associated with the peak FFT value 306. The flow continues to block 406.

At block 406, sub-channel counters can be incremented based, at least in part, on the FFT output values. In one embodiment, the sub-channel counters can be incremented by the sub-channel analysis unit 250. As described above, a sub-channel counter can be associated with one of the sub-channels of the wireless communication channel being used by wireless device 102. In one embodiment, a sub-channel counter can be incremented when the signal analysis module 106 determines that the peak FFT value 306 is included within the frequency band (or sub-channel) associated with the sub-channel counter. The flow continues to block 408.

At block 408, the wireless device 102 determines whether the wireless communication channel includes a radar signal based, at least in part, on a sub-channel counter. As described above, a sub-channel counter value (i.e., sub-channel counter information) can be used to determine if a radar signal is included in the corresponding sub-channel and, in some implementations, also the type of radar signal that is detected. For example, the value of the sub-channel counter can be used to determine if the corresponding sub-channel includes a type of hopping radar signal, chirping radar signal or fixed frequency radar signal. For example, a single, non-zero sub-channel counter can indicate a type of fixed frequency radar signal. Two or more adjacent, non-zero sub-channel counters can indicate a type of chirping radar signal. Two or more non-adjacent, non-zero sub-channel counters can indicate a type of hopping radar signal. In one embodiment, the largest sub-channel counter value can correspond to a sub-channel that can include a type of hopping radar signal, chirping radar signal or fixed frequency radar signal. If a sub-channel includes a radar signal, then the wireless device 102 can be configured to vacate operations in that sub-channel. Using sub-channel counter information to detect a radar signal and the type of radar signal is described in more detail below in conjunction with FIG. 5. The flow returns to block 402 to repeat the process.

FIG. 5 is a flow diagram 500 illustrating example operations of another embodiment of the wireless device 102. The flow diagram of FIG. 5 is described with reference to the wireless device 102 of FIG. 1 and more particularly to the signal analysis module 106 (for illustration purposes and not as a limitation). The example operations can be carried out by one or more components of the wireless device 102, such as a processor (not shown) or other modules within the wireless device 102 such as the wireless transceiver 104.

The flow begins at block 502, where the signal pulse information is received. As described above, the signal pulse information can include the signal pulse characteristics and the sub-channel counter information. In one embodiment, the signal pulse information can be generated by the wireless transceiver 104 in response to receiving the signal pulse. In another embodiment, the sub-channel counter information can be generated by the sub-channel analysis unit 250 in response to receiving the signal pulse. The flow continues to block 504.

At block 504, a radar type filter can be selected for processing the signal pulse information. In one embodiment, the radar type filter can be selected by the signal analysis module 106 based, at least in part, on the signal pulse characteristics. In one implementation, the type of radar signal can be a hopping radar signal, a chirping radar signal or a fixed frequency radar signal. The signal analysis unit 106 can compare the signal pulse characteristics of the received signal pulse with signal pulse characteristics of known radar signals to determine whether the received signal pulse is one of the types of known radar signals. The signal analysis unit 106 can then select the corresponding radar type filter. In other implementations, the signal analysis unit 106 can randomly select one of the radar type filters without considering the signal pulse characteristics. The radar type filter that is selected can be used to analyze the sub-channel counter information associated with the received signal pulse to determine (and confirm) whether the received signal pulse is a radar signal and the type of radar signal. In other implementations, the signal analysis unit 106 can select a subset or all of the available radar type filters at the same time for parallel processing without considering the signal pulse characteristics, as will be further described below. It is noted that although three types of radar signals are discussed above, in some implementations additional types of radar signals can be considered. The flow continues to block 506.

At block 506, the sub-channel counters can be validated in accordance with the operational mode of the wireless transceiver 104. Depending on the operational mode, the wireless transceiver 104 may not use all the sub-channels that are available. For example, in some operational modes, the wireless transceiver 104 may use a wireless communication channel that is less than 160 MHz wide. In these operational modes, only the sub-channel counters that correspond to the sub-channels used by the wireless transceiver 104 may be relevant for radar signal detection. The other sub-channel counters can correspond to unused sub-channels. Thus, the sub-channel counters corresponding to the sub-channels used by the wireless transceiver 104 can be validated. In other words, a validated sub-channel counter can correspond to a sub-channel used by the wireless transceiver 104 based on the operational mode. In contrast, sub-channel counters corresponding to unused sub-channels are not validated.

For example, as described above in FIG. 3, there can be eight sub-channel counters 314-321 each containing a value corresponding to a number of times that the peak FFT value 306 is detected within the corresponding sub-channel. In some operational modes, fewer than eight sub-channels may be used by the wireless device 102. In one instance, if the wireless device 102 is operating in the 20 MHz operational mode, then the sub-channel 4 may be used. In this operational mode, only the sub-channel 4 counter 317 may be validated. Other sub-channel counters corresponding to the sub-channels unused in the operational mode may not be validated and can be ignored. In another instance, if the wireless device 102 is operating in the 40 MHz operational mode, then the sub-channels 3 and 4 may be used. Therefore, the sub-channel 3 counter 316 and the sub-channel 4 counter 317 may be validated. If the operational mode of the wireless transceiver 104 includes 160 MHz of bandwidth, then all eight sub-channel counters 314-321 can be validated. The flow continues to block 508.

At block 508, if the radar type filter selected in block 504 is a hopping radar type filter, then the flow continues to block 526. At block 526, the validated sub-channel counters with non-zero values are mapped to corresponding sub-channel frequencies. In one embodiment, the signal analysis module 106 can determine whether the validated sub-channel counters with non-zero values are greater than the detection threshold. The detection threshold can reduce false radar signal detection by specifying a predetermined minimum validated sub-channel counter value (corresponding to a predetermined minimum number of peak FFT values 306 within the corresponding validated sub-channel) before determining that the radar signal is detected. For example, although a value of a validated sub-channel counter is non-zero, the sub-channel is determined to include the radar signal if the value of the validated sub-channel counter is greater than the detection threshold. As described above in FIG. 3, a sub-channel counter can correspond to particular sub-channel within the wireless communication channel. Mapping the validated sub-channel counter to the particular sub-channel frequencies associates the validated sub-channel counter with a particular frequency within the wireless communication channel. For example, one or more of the sub-channel counters 314-321 can be validated (at block 506) and can have a non-zero value or have a non-zero value that is greater than the detection threshold. These one or more validated sub-channel counters 314-321 can correspond to sub-channels that include the radar signal. These one or more validated sub-channel counters 314-321 can then be mapped to particular sub-channel frequencies. Since the hopping radar signal can appear in non-adjacent sub-channels, one or more validated sub-channel counters 314-321 that correspond to the non-adjacent sub-channels may include non-zero values or values that are greater than the detection threshold. The flow continues to block 516.

At block 516, the mapped sub-channel frequency (i.e., the sub-channel that includes the radar signal) is marked. The mapped sub-channel frequency can be marked to indicate that the corresponding sub-channel can include the radar signal and can be vacated. In some implementations, more than one sub-channel frequency can be mapped, and therefore more than one sub-channel can be vacated. In some embodiments, the wireless transceiver 104 can detect the marked sub-channel frequencies and vacate the corresponding frequencies. In one implementation, the mapped sub-channel frequency can be marked using a hardware bit (such a bit in a hardware register) or a software-based flag. The flow continues to block 518. At block 518, the sub-channel counters can be reset (initialized) and the flow returns to block 502. Resetting the sub-channel counters can prepare the wireless device 102 to detect radar signals.

Returning to block 508, if the radar type filter selected in block 504 is not a hopping radar type filter, then the flow continues to block 510. At block 510, a validated sub-channel counter with the largest value is determined. The validated sub-channel counter with the largest value can correspond to the sub-channel that may include a non-hopping radar signal (e.g., a chirping radar signal or a fixed frequency radar signal). In one embodiment, the validated sub-channel counter with the largest value can correspond to the sub-channel that had the most peak FFT values 306 through the time period when the FFT outputs 302 are provided by the FFT module 230. In some embodiments, the validated sub-channel counter with the largest value can also be greater than the detection threshold to reduce false radar signal detection. In one example, other validated sub-channel counters without the largest value may not include the radar signal. For example, other validated sub-channel counters can have non-zero values (that are less than the detection threshold) due to spurious or transient noise. The flow continues to block 512.

At block 512, if the radar type filter selected in block 504 is not a chirping radar type filter (e.g., the type of radar signal selected is a fixed frequency radar signal), then the flow continues to block 514. At block 514, the validated sub-channel counter with the largest value is mapped to the corresponding sub-channel frequency. The validated sub-channel counter with the largest value can correspond to the sub-channel that can include the fixed frequency radar signal. Mapping the validated sub-channel counter with the largest value to the corresponding sub-channel frequency associates the validated sub-channel counter with a particular frequency within the wireless communication channel. In one embodiment, the validated sub-channel counter with the largest value can be mapped in a manner similar to that described in block 526. The flow continues to block 516.

Returning to block 512, if the radar type filter selected in block 504 is a chirping radar type filter, then the flow continues to block 520. At block 520, a validated sub-channel counter with the second largest value is determined. In many chirping radar implementations, the chirp frequency can be between 5 and 20 MHz. Therefore, the peak FFT values 306 from a chirping radar signal can appear in two adjacent sub-channels. Two adjacent, validated sub-channel counters can have large and possibly similar values when the wireless transceiver 104 operates in the presence of a chirping radar signal. The validated sub-channel counter with the second largest value can correspond to a second sub-channel that can include the chirping radar signal. In one embodiment, the value of the largest and second largest validated sub-channel counters can each be greater than the detection threshold. The flow continues to block 522.

At block 522, the sub-channels corresponding to the validated sub-channel counters with the largest and the second largest values are determined to be adjacent. In one embodiment, adjacent sub-channels can be determined by adjacent sub-channel counters. For example, when the sub-channel counter 3 316 is adjacent to the sub-counter channel 4 317, the corresponding sub-channels (the sub-channel 3 and the sub-channel 4) can also be adjacent. The adjacent, validated sub-channel counters can detect a chirping radar signal in the corresponding adjacent sub-channels. In other implementations, the signal analysis module 106 can determine whether the difference between the largest and the second largest values of the validated sub-channel counters is less than a chirp difference threshold to determine the presence of a chirping radar signal. The chirp difference threshold can be a predetermined value expressing the largest allowable difference between values of the validated sub-channel counters for chirping radar signals. In this embodiment, if the sub-channels corresponding to the validated sub-channel counters with the largest and the second largest values are determined to be adjacent and the difference between the largest and the second largest values of the validated sub-channel counters is less than the chirp difference threshold, then a chirping radar signal is detected. If the sub-channels corresponding to the validated sub-channel counters with the largest and the second largest values are adjacent, then the flow continues to block 524.

At block 524, the validated sub-channel counters with the largest and second largest values are mapped to the corresponding sub-channel frequencies. Mapping the validated sub-channel counters to the corresponding sub-channel frequencies associates the validated sub-channel counters with the largest and second largest values with particular frequencies within the wireless communication channel. In one embodiment, the validated sub-channel counters with the largest and second largest values can be mapped in a manner similar to that described in block 526. The flow continues to block 516

Returning to block 522, if the sub-channels corresponding to the validated sub-channel counters with the largest and the second largest values are not adjacent, then the flow continues to block 514. In one example, the second largest value of the validated sub-channel can be due to noise or other error, such as a signal pulse that is not a radar signal but whose frequency spectrum may appear to be narrowband. In this example, the validated sub-channel counter with the largest value can be due to a fixed frequency radar signal. However, the validated sub-channel counter with the second largest value can be ignored. As described above, in block 514, the validated sub-channel counter with the largest value is mapped to the corresponding sub-channel frequency.

In another embodiment, portions of the flow illustrated in FIG. 5 can be performed in parallel. For example, operations related to a hopping radar signal (e.g., blocks 508 and 526), operations related to a chirping radar signal (e.g., blocks 510, 512, 520, 522 and 524) and operations related to a fixed frequency radar signal (e.g., blocks 510, 512 and 514) can be performed in parallel, instead of serially as described above. For example, the signal analysis module 106 can select at least a subset of the available radar type filters for parallel processing. In one embodiment, the sub-channel counters 314-321 can be implemented centrally in the counter array 310 as described in FIG. 3.

FIG. 6 is a flow diagram 600 illustrating example operations of yet another embodiment of the wireless device 102. In this embodiment, a frequency spread of the FFT output 302 or the peak FFT value 306 can be monitored over the course of the detection time period. When a signal pulse is detected, characteristics of the signal pulse (e.g., available through the signal pulse information) can be compared with the signal characteristics of known radar signals to detect the presence of radar signals. The frequency spread information can be used in addition to the signal pulse characteristics to determine if a radar signal is present within a frequency band used by the wireless device 102.

The flow begins at block 602 where signal pulses are detected. In one embodiment, the signal pulses can be detected by the wireless transceiver 104. In one implementation, the pulse characterization module 205 can determine signal pulse characteristics associated with the signal pulses detected by the wireless transceiver 104. For example, the signal pulse characteristics can include a pulse count that describes a number of signal pulses that have been detected. In one embodiment, the pulse count can be determined by the pulse counter 237 included in the pulse characterization module 205. The flow continues to block 604.

At block 604, the number of signal pulses that are detected (or the pulse count) can be compared to a minimum number of signal pulses (M) used for pattern matching to a known radar signal. In one implementation, the signal analysis module 106 can compare the number of detected signal pulses to the minimum number of signal pulses. For example, the minimum number of signal pulses can be used for pattern matching to a chirping radar signal. Other radar signal types (e.g. a hopping radar signal and the fixed frequency radar signal) can have a different number of minimum signal pulses. If the minimum number of signal pulses has not been detected, then the flow returns to block 602. If the minimum number of pulses has been detected, then the flow continues to block 606.

At block 606, a frequency spread information can be determined. Frequency spread information can be determined by tracking a minimum frequency (Fmin) and a maximum frequency (Fmax) of the FFT output 302 during the detection time period. In one implementation, the frequency spread information can be determined by the sub-channel analysis unit 250. Frequency spread information can be used with operational mode information to determine if a radar signal is detected within the wireless communication channel used by the wireless device 102. The flow continues to block 608.

At block 608, the signal pulse characteristics and the frequency spread information can be compared to the signal characteristics and the frequency spread information of known radar signals. This comparison can determine if a radar signal is present in the wireless communication channel used by the wireless transceiver 104. The frequency spread information can be used to determine if the signal pulses are within an allowable frequency spread (bandwidth) for a particular radar signal type. For example, the frequency spread information can be used to determine if the signal pulses can be chirping radar signals. Expressed as an equation, if Fmax−Fmin>a chirping radar bandwidth, then the signal pulse is not a chirping radar signal. For a more general expression, if Fmax−Fmin>allowable frequency spread for a particular radar signal, then the signal pulse is not that particular radar signal. The flow continues to block 610.

At block 610, if the signal pulse characteristics and frequency spread information do not match a known radar signal, then the flow returns to block 602. On the other hand, if the signal pulse characteristics and frequency spread information match a known radar signal, then the flow continues to block 614.

At block 614, sub-channels that include radar signals are marked. The sub-channels can be portions of the wireless communication channel as described above in FIG. 3. A sub-channel can include a radar signal when the signal pulse characteristics and frequency spread information of the signal pulse match a known radar signal. Additionally, the frequency of the signal pulse can be included within the frequency of the sub-channel. Marking the sub-channel can indicate that the associated frequency may include a radar signal and should be vacated. The marked sub-channels can be detected by hardware modules or software routines or a combination of both. The frequency spread information can be reset (i.e., Fmin and Fmax can be reset to initial values) and the flow can return to block 602.

It should be understood that FIGS. 1-6 and the operations described herein are examples meant to aid in understanding embodiments and should not be used to limit embodiments or limit scope of the claims. Embodiments may perform additional operations, fewer operations, operations in a different order, operations in parallel, and some operations differently. The disclosed embodiments are not meant to limit the inventive subject matter. Other embodiments are contemplated.

For example, in one embodiment, if the frequency spread information is greater than a chirping radar bandwidth (and the wireless device 102 is operating in a region that does not permit a hopping radar signal), then in block 610 the frequency spread information can be reset and the flow returns to block 602. No radar signals may be matched since the frequency spread information may not be correct, which could lead to a false detection.

As will be appreciated by one skilled in the art, aspects of the present inventive subject matter may be embodied as a system, method, or computer program product. Accordingly, aspects of the present inventive subject matter may take the form of an entirely hardware embodiment, a software embodiment (including firmware, resident software, micro-code, etc.) or an embodiment combining software and hardware aspects that may all generally be referred to herein as a “circuit,” “module”, “unit”, “device” or “system.” Furthermore, aspects of the present inventive subject matter may take the form of a computer program product embodied in one or more computer readable medium(s) having computer readable program code embodied thereon.

Any combination of one or more computer readable medium(s) may be used. The computer readable medium may be a computer readable storage medium. A computer readable storage medium may be, for example, an electronic, magnetic, optical, electromagnetic, infrared, or semiconductor system, apparatus, or device, or any suitable combination of the foregoing. More specific examples of the computer readable storage medium may include a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The computer readable medium can include instructions for carrying out operations for aspects of the present inventive subject matter and may be written in any combination of one or more programming languages. Examples of programming languages can include an object oriented programming language such as Java, Smalltalk, C++ or the like and conventional procedural programming languages, such as the “C” programming language. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to be executed.

The computer program instructions can be executed to direct a computer, other programmable data processing apparatus, or other devices to function in a particular manner in order to produce an article of manufacture including instructions which implement the function/act specified in the flowchart and/or block diagram block or blocks.

The computer program instructions may also be loaded onto a computer, other programmable data processing apparatus, or other devices. The computer program instructions can be executed to cause a series of operational steps to be performed to produce a computer implemented process such that the executed instructions can provide processes for implementing the functions/acts specified in the flowchart and/or block diagram block or blocks.

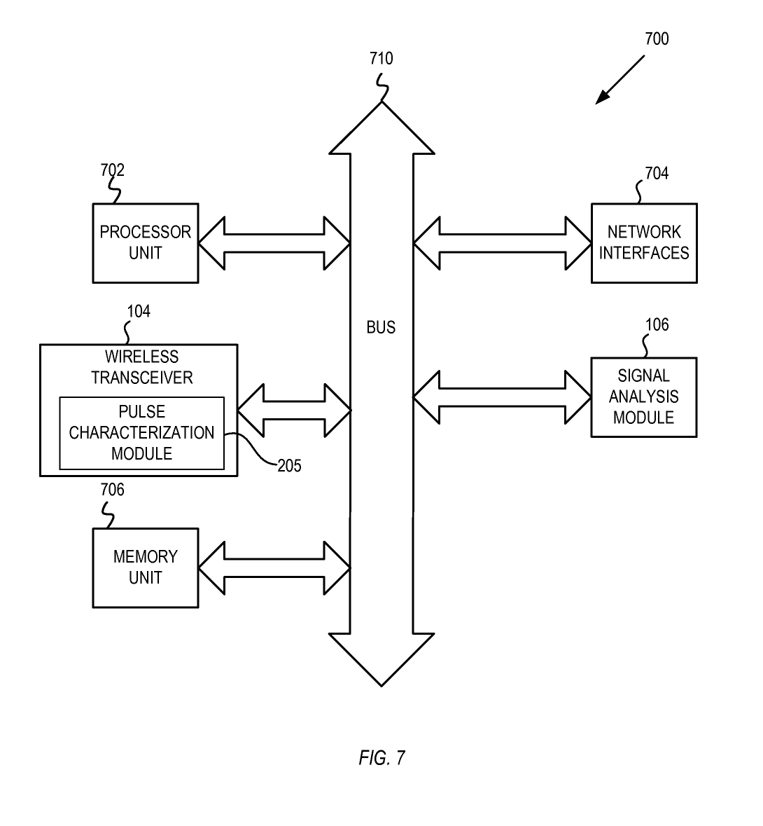

FIG. 7 is a block diagram of one embodiment of an electronic device 700 including the pulse characterization module 205. In some implementations, the electronic device 700 may be one of a laptop computer, a tablet computer, a mobile phone, a hybrid communication device, a smart appliance, an access point, or other electronic systems. The electronic device 700 can include processor unit 702 (possibly including multiple processors, multiple cores, multiple nodes, and/or implementing multi-threading, etc.). The electronic device 700 can also include a memory unit 706. The memory unit 706 may be a system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The electronic device 700 can also include a bus 710 (e.g., PCI, ISA, PCI-Express, HyperTransport®, InfiniBand®, NuBus, AHB, AXI, etc.). The electronic device 700 can include a network interface 704 that includes at least one of a wireless network interface (e.g., a WLAN interface, a BLUETOOTH® interface, a WiMAX interface, a ZigBee® interface, a Wireless USB interface, LTE, CDMA2000, etc.) and a wired network interface (e.g., an Ethernet interface, a powerline communication interface, etc.). In some implementations, the electronic device 700 may support multiple network interfaces—each of which is configured to couple the electronic device 700 to a different communication network.

The electronic device 700 can also include the wireless transceiver 104 and the signal analysis module 106. The wireless transceiver 104 can include the pulse characterization module 205 and other elements and modules described above with reference to FIGS. 1-6. For example, the pulse characterization module 205 can operate as described above in conjunction with FIG. 2. The signal analysis module 106 can operate as described above in conjunction with FIGS. 1-2. The wireless transceiver 104 and the signal analysis module 106 can be coupled to the bus 710. In one embodiment, the memory unit 706 can store instructions that are executable by the processor unit 702 to implement embodiments described in FIGS. 1-6 above. Although shown separately, in some embodiments, the signal analysis module 106 can be implemented using the memory unit 706 and the processor unit 702. For example, the processor unit 702 can execute instructions stored in the memory unit 706 to provide functionality for the signal analysis module 106. Any one of these functionalities described herein may be partially (or entirely) implemented in hardware and/or on the processor unit 702. For example, the functionality may be implemented with an application specific integrated circuit, in logic implemented in the processor unit 702, in a co-processor on a peripheral device or card, etc. Further, realizations may include fewer or additional components not illustrated in FIG. 7 (e.g., video cards, audio cards, additional network interfaces, peripheral devices, etc.). The processor unit 702, the memory unit 706, the network interface 704 and the wireless transceiver 104 are coupled to the bus 710. Although illustrated as being coupled to the bus 710, the memory unit 706 may be coupled to the processor unit 702.

While the embodiments are described with reference to various implementations and exploitations, it will be understood that these embodiments are illustrative and that the scope of the inventive subject matter is not limited to them. In general, techniques for radar signal detection as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
receiving, at a wireless device, a signal pulse via a wireless communication channel, wherein the wireless communication channel includes a first sub-channel;
generating a Fast Fourier Transform (FFT) value from the signal pulse;
incrementing a first sub-channel counter based, at least in part, on the FFT value, wherein the first sub-channel counter is associated with the first sub-channel; and
determining whether the wireless communication channel includes a radar signal based, at least in part, on the first sub-channel counter.

2. The method of claim 1, further comprising:
validating the first sub-channel counter based, at least in part, on an operational mode of the wireless device,
wherein determining whether the wireless communication channel includes the radar signal is based, at least in part, on the validated first sub-channel counter.

3. The method of claim 2, wherein validating the first sub-channel counter comprises determining whether the first sub-channel counter is assigned to a frequency used in the operational mode of the wireless device.

4. The method of claim 1, further comprising:
generating a sub-channel mask based, at least in part, on the FFT value.

5. The method of claim 4, wherein incrementing the first sub-channel counter is based, at least in part, on the sub-channel mask.

6. The method of claim 1, wherein determining whether the wireless communication channel includes the radar signal further comprises:
determining whether the first sub-channel counter is greater than a detection threshold; and
determining that the first sub-channel includes the radar signal based, at least in part, on determining that the first sub-channel counter is greater than the detection threshold.

7. The method of claim 1, further comprising:
incrementing a second sub-channel counter based, at least in part, on the FFT value, wherein the second sub-channel counter is associated with a second sub-channel of the wireless communication channel,
wherein determining whether the wireless communication channel includes the radar signal is based, at least in part, on the first sub-channel counter and the second sub-channel counter.

8. The method of claim 7, wherein the first sub-channel is separated from the second sub-channel by a frequency band.

9. The method of claim 7, wherein determining whether the wireless communication channel includes the radar signal further comprises:
determining whether the first sub-channel counter and the second sub-channel counter are greater than a detection threshold; and
determining that the first sub-channel and the second sub-channel include the radar signal based, at least in part, on determining that the first sub-channel counter and the second sub-channel counter are greater than the detection threshold.

10. The method of claim 7, wherein the first sub-channel is adjacent to the second sub-channel.

11. The method of claim 7, wherein determining whether the wireless communication channel includes the radar signal further comprises:
determining whether a difference between the first sub-channel counter and the second sub-channel counter is less than a chirp difference threshold; and
determining that the first sub-channel and the second sub-channel include the radar signal based, at least in part, on determining that the difference between the first sub-channel counter and the second sub-channel counter is less than the chirp difference threshold.

12. The method of claim 1, further comprising:
in response to determining that the wireless communication channel includes the radar signal, vacating operations of the wireless device in the first sub-channel while maintaining operations of the wireless device in another sub-channel of the wireless communication channel.

13. The method of claim 1, wherein an operational mode of the wireless device is in accordance with an IEEE 802.11 ac draft specification.

14. A method comprising:
receiving, at a wireless device, a plurality of signal pulses via a wireless communication channel, wherein the wireless communication channel includes a first sub-channel and a second sub-channel;
generating Fast Fourier Transform (FFT) values from the plurality of signal pulses;
incrementing a first sub-channel counter associated with the first sub-channel and a second sub-channel counter associated with the second sub-channel based, at least in part, on the FFT values; and
determining whether the wireless communication channel includes a radar signal and determining a type of the radar signal based, at least in part, on the first sub-channel counter and the second sub-channel counter.

15. The method of claim 14, wherein determining whether the wireless communication channel includes the radar signal is based, at least in part, on determining that at least one of the first sub-channel counter and the second sub-channel counter includes a non-zero count.

16. The method of claim 14, wherein determining whether the wireless communication channel includes the radar signal and determining the type of the radar signal further comprises:
determining whether the first sub-channel counter and the second sub-channel counter are greater than a detection threshold; and
determining that the wireless communication channel includes a first type of radar signal based, at least in part, on determining that the first sub-channel counter and the second sub-channel counter are greater than the detection threshold, and that the first sub-channel is separated from the second sub-channel by a frequency band.

17. The method of claim 14, wherein determining whether the wireless communication channel includes the radar signal and determining the type of the radar signal further comprises:
determining whether the first sub-channel counter and the second sub-channel counter are greater than a detection threshold; and
determining that the wireless communication channel includes a first type of radar signal based, at least in part, on determining that the first sub-channel counter and the second sub-channel counter are greater than the detection threshold, and that the first sub-channel is adjacent to the second sub-channel.

18. A wireless device comprising:
a wireless receiver configured to:
receive a signal pulse via a wireless communication channel, wherein the wireless communication channel includes a first sub-channel, and
generate a Fast Fourier Transform (FFT) value based, at least in part, on the signal pulse; and
a signal analysis module configured to:
increment a first sub-channel counter based, at least in part, on the FFT value, wherein the first sub-channel counter is associated with the first sub-channel, and
determine whether the wireless communication channel includes a radar signal based, at least in part, on the first sub-channel counter.

19. The wireless device of claim 18, wherein the signal analysis module is further configured to:
validate the first sub-channel counter based, at least in part, on an operational mode of the wireless device,
wherein the signal analysis module configured to determine whether the wireless communication channel includes the radar signal is based, at least in part, on the validated first sub-channel counter.

20. The wireless device of claim 19, wherein the signal analysis module is further configured to validate the first sub-channel counter based, at least in part, on whether the first sub-channel counter is assigned to a frequency used in the operational mode of the wireless device.

21. The wireless device of claim 18, wherein the signal analysis module is further configured to generate a sub-channel mask based, at least in part, on the FFT value.

22. The wireless device of claim 21, wherein the signal analysis module is further configured to increment the first sub-channel based, at least in part, on the sub-channel mask.

23. The wireless device of claim 18, wherein the signal analysis module is further configured to:
increment a second sub-channel counter based, at least in part, on the FFT value, wherein the second sub-channel counter is associated with a second sub-channel of the wireless communication channel,
wherein the signal analysis module configured to determine whether the wireless communication channel includes the radar signal is based, at least in part, on the first sub-channel counter and the second sub-channel counter.

24. The wireless device of claim 23, wherein the first sub-channel is separated from the second sub-channel by a frequency band.

25. The wireless device of claim 23, wherein the signal analysis module is further configured to:
determine whether the first sub-channel counter and the second sub-channel counter are greater than a detection threshold, and
determine that the first sub-channel and the second sub-channel include the radar signal based, at least in part, on determining that the first sub-channel counter and the second sub-channel counter are greater than the detection threshold.

26. The wireless device of claim 23, wherein the first sub-channel is adjacent to the second sub-channel.

27. The wireless device of claim 23, wherein the signal analysis module is further configured to:
determine whether a difference between the first sub-channel counter and the second sub-channel counter is less than a chirp difference threshold; and
determine that the first sub-channel and the second sub-channel include the radar signal based, at least in part, on determining that the difference between the first sub-channel counter and the second sub-channel counter is less than the chirp difference threshold.

28. A non-transitory machine-readable storage medium having machine executable instructions stored therein, the machine executable instructions comprising instructions to:
receive, by a wireless device, a signal pulse via a wireless communication channel, wherein the wireless communication channel includes a first sub-channel;
generate a Fast Fourier Transform (FFT) value from the signal pulse;
increment a first sub-channel counter based, at least in part, on the FFT value, wherein the first sub-channel counter is associated with the first sub-channel; and
determine whether the wireless communication channel includes a radar signal based, at least in part, on the first sub-channel counter.

29. The non-transitory machine-readable storage medium of claim 28, further comprising instructions to:
determine whether the first sub-channel counter is greater than a detection threshold; and
determine that the first sub-channel includes the radar signal based, at least in part, on determining that the first sub-channel counter is greater than the detection threshold.

30. The non-transitory machine-readable storage medium of claim 28, further comprising instructions to:
increment a second sub-channel counter based, at least in part, on the FFT value, wherein the second sub-channel counter is associated with a second sub-channel of the wireless communication channel; and
determine whether the wireless communication channel includes the radar signal based, at least in part, on the first sub-channel counter and the second sub-channel counter.
